(19) United States
(12) Patent Application Publication
(10) Pub. No.: US 2014/0288769 A1
(43) Pub. Date: Sep. 25, 2014

(54) HITCH ANGLE ESTIMATION

(71) Applicant: FORD GLOBAL TECHNOLOGIES, Dearborn, MI (US)

(72) Inventors: Roger Arnold Trombley, Ann Arbor, MI (US); Thomas Edward Pilutti, Ann Arbor, MI (US); Christopher Nave, Ypsilanti, MI (US); John Shutko, Ann Arbor, MI (US)

(73) Assignee: Ford Global Technologies, Dearborn, MI (US)

(21) Appl. No.: 13/847,508

(22) Filed: Mar. 20, 2013

(51) Int. Cl. G06F 17/00

(52) U.S. Cl. CPC G06F 17/00
USPC 701/34.4

(57) ABSTRACT

A method and system for estimating hitch angle between a vehicle and a trailer coupled thereto. The system has a wireless receiver on the vehicle located a predetermined distance from a trailer mount, a wireless transmitter located at an end of the trailer opposite the trailer mount, and a controller for monitoring power returns of a signal transmitted from the transmitter to the receiver and for estimating a distance between the transmitter and the receiver as a function of a path loss propagation of the transmitted signal. The bitch angle is estimated using the estimated distance, the predetermined distance and a trailer length.

### CROSS REFERENCE TO RELATED APPLICATIONS

The inventive subject matter is related to co-pending U.S. patent application Ser. No. 13/772,415 (Attorney Docket Number 8337814) entitled Trailer Length Estimation assigned to the assignee of the inventive subject matter. The subject matter of which is incorporated herein by reference.

### TECHNICAL FIELD

The inventive subject matter is directed to a system and method for estimating an angle between a vehicle and a trailer attached to the vehicle, known as hitch angle.

### BACKGROUND

For a motor vehicle that has a trailer attached, or hitched, thereto, it is advantageous for a plurality of vehicle systems to use information that is representative of an angle between the vehicle and a trailer attached to the vehicle, also known as a hitch angle. Many vehicle systems utilize hitch angle information as an input to the system which input is manipulated by a controller or microprocessor associated with the vehicle system. Current methods for supplying a hitch angle to a requesting system rely on sensor information that may or may not provide an accurate measurement of the hitch angle. A hitch angle that is not accurate may introduce a potential for inadequate or improper vehicle system control, especially in situations where the hitch angle information is important to the vehicle system being controlled, such as a trailer backup assist system or a trailer brake controller.

There is a need for an accurate estimate of a hitch angle. There is also and a need to check or verify the accuracy of a hitch angle measurement taken from a sensor that may be otherwise unreliable.

### SUMMARY

The inventive subject matter is a system and method for estimating hitch angle that provides a reliable estimate of hitch angle and does not rely on a hitch angle measurement taken by a sensor that may be otherwise unreliable. The inventive subject matter provides a reliable estimate of the hitch angle that may be used as an input to various vehicle control systems. The system and method of the inventive subject matter may also be used to verify or check the accuracy of a hitch angle provided by a hitch angle sensor on the vehicle to ensure that vehicle systems that request hitch angle as an input to control algorithms are receiving an accurate estimate or measurement.

A system for estimating a hitch angle between a trailer having a transmitter disposed thereon coupled to a vehicle having a trailer mount and a receiver disposed on the vehicle a first distance from the trailer mount. The system has a controller to calculate a second distance between the transmitter and the receiver as a function of path loss propagation and estimate a hitch angle using the first distance, the second distance and a trailer length.

A method executed by a controller on a vehicle for calculating an angle between a vehicle and a trailer coupled thereto. The method monitors power returns of a signal transmitted from a wireless transmitter at one end of the trailer to a wireless receiver on the vehicle located a predetermined distance from a trailer mount, estimates a distance between the transmitter and the receiver, the estimated distance being a function of a path loss propagation of the transmitted signal, calculates an angle between the vehicle and the trailer using the estimated distance, the predetermined distance and a trailer length, and outputs the calculated angle to a vehicle system.

### DESCRIPTION OF DRAWINGS

FIG. 1 is an automotive vehicle having a hitch angle estimating system of the inventive subject matter;

FIG. 2 is a block, diagram of a vehicle having a trailer coupled thereto and a relationship to the law of cosines; and

FIG. 3 is a flow chart of a method of the inventive subject matter.

Elements and steps in the figures are illustrated for simplicity and clarity and have not necessarily been rendered according to any particular sequence. For example, steps that may be performed concurrently or in different order are illustrated in the figures to help to improve understanding of embodiments of the inventive subject matter.

### DESCRIPTION OF INVENTION

While various aspects of the inventive subject matter are described with reference to a particular illustrative embodiment, the inventive subject matter is not limited to such embodiments, and additional modifications, applications, and embodiments may be implemented without departing from the inventive subject matter. In the figures, like reference numbers will be used to illustrate the same components. Those skilled in the art will recognize that the various components set forth herein may be altered without varying from the scope of the inventive subject matter.

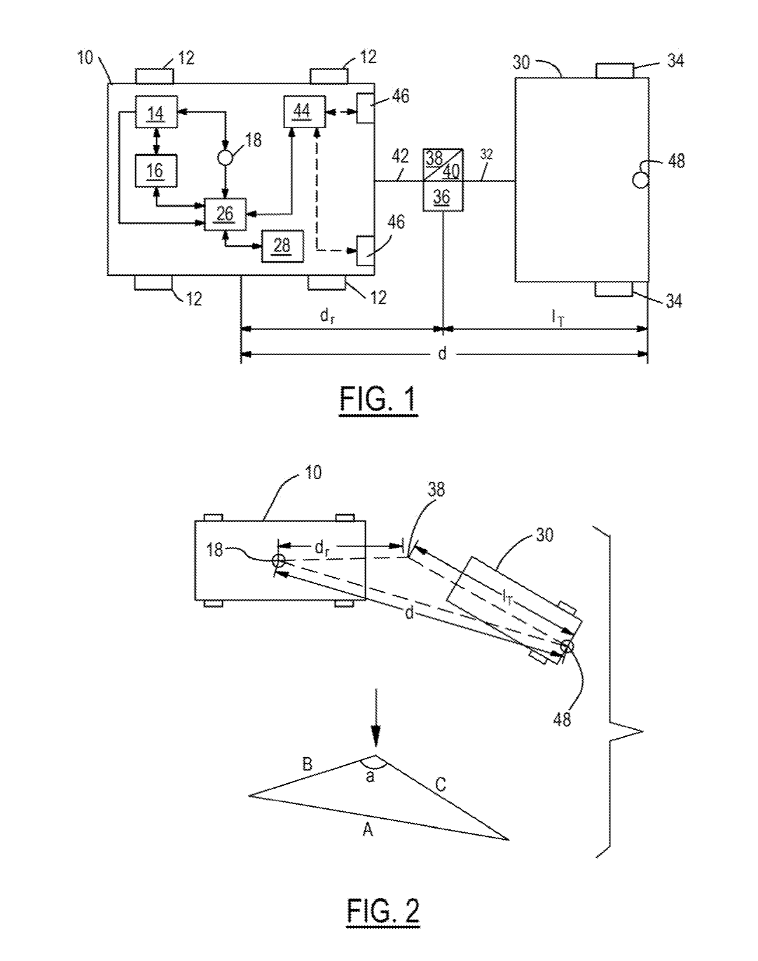

FIG. 1 is an automotive vehicle 10 with a hitch angle estimating system of the inventive subject matter. The vehicle 10 has tires 12. The vehicle 10 may also have one or more sensing systems 14 that have a plurality of sensors positioned in on and around the vehicle 10. The vehicle also has a number of different types of control systems 16 that utilize sensor information collected by the sensing systems 14.

Sensing systems 14 and vehicle control systems 16 may share sensors with other vehicle dynamic control systems such as a yaw stability control system sensor set or a roll stability control system sensor set. Actual sensors on the vehicle 10 will vary depending on the type of control systems 16 implemented on the particular vehicle 10. Some examples include, but are not limited to, wireless sensors, wheel speed sensors, lidar, radar, sonar, camera(s), and GPS. Angular rate sensors and accelerometers may also be included and are typically mounted on the vehicle along the body frame. For example, a longitudinal acceleration sensor, a lateral acceleration sensor and a vertical acceleration sensor may each be mounted on the vehicle 10 at its center of gravity. A wireless sensing receiver 18 is also included and is mounted at a known vehicle location, such as a central vehicle body position.

Any one of the control systems 16 may have a controller 26, which may be a single centralized vehicle controller or a combination of controllers. If many controllers are used, they may be coupled together to communicate information, as well as arbitrate and prioritize information and instructions among multiple controllers. The controller 26 may be micro-processor based. The controller 26 may comprise a data processing device, such as a non-transitory computer readable medium, and instructions on the computer readable medium for carrying out estimation of hitch angle. The controller 26 may have various signal interfaces for receiving and outputting signals. As discussed above, hitch angle estimation may be implemented logically in a stand-alone component or in a distributed manner where a plurality of controllers, control units, modules, computers, or the like jointly carry out operations for estimating hitch angle.

The controller 26 may be programmed to perform various functions and control various outputs. Controller 26 may have a memory 28 associated therewith. Memory 2 may be a stand-alone memory or may be incorporated into the controller 26. Memory 28 may store various parameters, thresholds, patterns, tables, or maps. For example, parameters may include known, fixed vehicle measurements such as wheel base, vehicle length, trailer length and distances from known parts of the vehicle.

The controller 26 receives information from a number of sensors associated with the sensing systems 14. Again, the sensor systems 14 may include, but are not limited to speed sensors, yaw rate sensor, lateral acceleration sensor, roll rate sensor, vertical acceleration sensor, a longitudinal acceleration sensor, a pitch rate sensor, and a steering angle position sensor. These sensors may also be part of an inertial measurement unit that would most likely be located at the center of the vehicle body.

A trailer 30 may be towed behind vehicle 10. Trailer 30 may include to tongue 32 aid trailer wheels 34. Trailer 30 may also include a trailer brake and electrical components such as lights (not shown in FIG. 1). A wiring harness 36 may be used to couple the trailer to the electrical system of the vehicle 10 and ultimately to the controller 26.

The trailer 30 is coupled to the vehicle 10, as by a hitch ball or other mount 42 on the vehicle, through a hitch 38 located at the end of the trailer tongue 32. A distance dᵣ defines a reference distance which is the distance between the wireless receiver 18 on the vehicle and the hitch ball or other mount 42 on the vehicle. This is a fixed distance and may be stored in memory 28. The hitch 38 may have a hitch angle sensor 40 associated therewith. Alternatively, the hitch angle sensor 40 may be associated with the mount 42. The hitch angle sensor 40 is used to determine the angle position of the trailer 30 relative to the vehicle 10. Various types of hitch angle sensors, such as resistive, inductive, ultrasonic, or capacitive type sensors may be used to determine the relative angle of the trailer 30 with respect to the vehicle 10. Another system that may be used to determine the position of the trailer 30 relative to the vehicle 10 is a reverse aid system 44 on the vehicle 10. The reverse aid system has a plurality of sensors and/or cameras 46 and may be coupled to the controller 26. Reverse aid sensors 46 may be an ultrasonic sensor, a radar sensor, or a combination of the two. Reverse aid sensors are typically located at several locations at the rear of the vehicle 10, such as in the bumper. Other ways to determine the position of the trailer 30 may include cameras located on the trailer, the vehicle or as part of the reverse-aid sensors 46.

Many of the hitch angle sensing devices discussed above may be unreliable, or their measurements may be such a crucial aspect of the vehicle system being controlled that ongoing verification of their accuracy is needed. Alternatively, the vehicle-trailer combination may not be equipped with a hitch angle sensor, yet hitch angle may be necessary for controlling a vehicle system when a trailer is attached to the vehicle. The inventive subject matter estimates a hitch angle between a vehicle and a sensor in a manner that does not require a hitch angle sensor. In addition to providing, a hitch angle estimate, the inventive subject matter may also be used to estimate a hitch angle that is compared to a sensed hitch angle in order to verify the accuracy of a physical measurement of hitch angle taken by a hitch angle sensor.

A wireless transmitter 48 is positioned on the trailer 30 at a known location, preferably at the end of the trailer. This wireless transmitter 48 is in communication with the wireless sensing receiver 18 that is located on the vehicle 10. The wireless sensing receiver 18 has been placed at a known location of the vehicle such that a reference distance, dᵣ, from the receiver 18 to the hitch 38 at the rear of the vehicle 10 is known and stored in memory 28. Examples of wireless transmitting and receiving devices that may be used are Radio Frequency Identification (RFID), Bluetooth and the like. As discussed above, the wireless receiver 18 is positioned at a location on the vehicle 10 the predetermined distance, dr, from the vehicle's trailer mount 42 or hitch 38. The wireless transmitter 48 and the wireless receiver 18 are compatible units that transmit and receive signals between the vehicle 10 and the trailer 30. The controller monitors the power returns of the transmitted signals. By monitoring the power returns of signals sent by the transmitter to the receiver, the controller 26 may estimate a distance, d, between the vehicle 10 and the trailer 30.

The inventive subject matter also uses a trailer length, lᵣ. This value may be a known value entered by the driver, stored in controller memory, or otherwise sensed, calculated or estimated. For example, an accurate estimate of trailer length, l_{T}, is possible using measurements of the signal transmitted from the wireless transmitter 48 on the trailer to the wireless receiver 18 on the vehicle 10 when the hitch angle is zero. it is also possible to estimate the trailer length when the measurements are taken while the vehicle yaw rate is zero for a predetermined period of time. These methods will be described in detail later herein.

The inventive subject matter estimates the hitch angle using the trailer length, lᵣ, and path loss propagation of a signal transmitted from the transmitter 48 on the trailer 30 to the receiver 18 on the vehicle 10. The hitch angle estimate may then be used as an input for control algorithms associated with a variety of vehicle systems 16 such as trailer sway, trailer backup assist, stability control and other systems. Alternatively, the hitch angle estimate may be used to verify, or validate, the measurement taken by a hitch angle sensor.

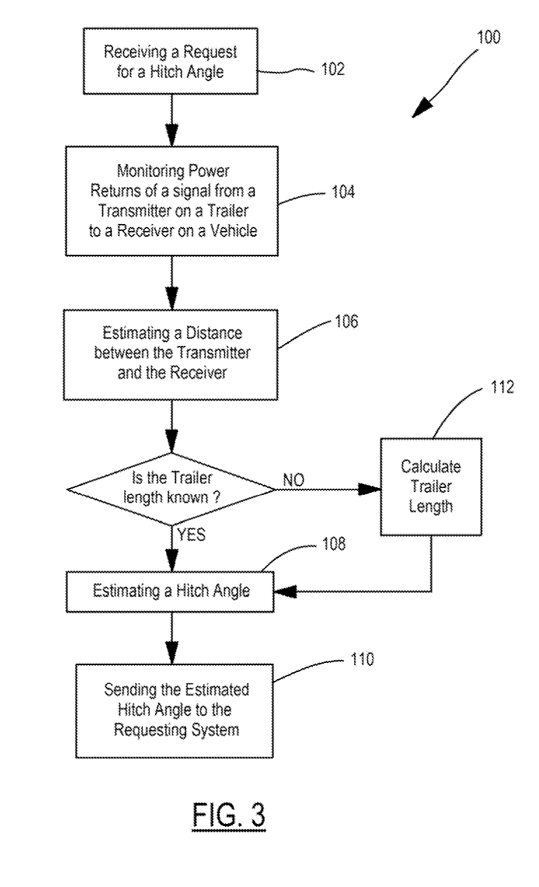

Referring to FIG. 2, a block diagram of a vehicle 10 and trailer 30 combination, where a hitch angle is non-zero, is shown with respect to the law of cosines: A²=B²+C²−2BC cos(α). The vehicle 10 has the trailer 30 attached thereto with the receiver 18 located on the vehicle a predetermined reference distance, dᵣ from the trailer hitch 38, which corresponds to B for the triangle reflecting the law of cosines in FIG. 2. The trailer length, l_{T}, is shown and the transmitter 48 is located at the end of the trailer 30. The trailer length, l_{T}, corresponds to C in the law of cosines. The distance, d, between the transmitter 48 and the receiver 18 is shown, which corresponds to A in the law of cosines. The reference distance, dᵣ, is a known distance that may be stored in memory 28. The trailer length, l_{T}, may also be a known distance that is stored in memory 28 or it may be estimated or calculated as described later herein. The distance, d, is calculated as described hereinafter with reference to FIG. 3.

Referring to FIG. 3, a flow chart of the method 100 for estimating a hitch angle in accordance with the inventive subject matter is shown. The method 100 can be carried out using the vehicle and trailer architecture discussed above in reference to the vehicle 10 and trailer 30 for FIG. 1. Accordingly the hitch angle estimate may be supplied to any vehicle system 16 requesting the information.

An operation 102 is performed for requesting hitch angle estimation. A request for hitch angle estimation may come from a vehicle control system 16 that requires the information as an input to the control algorithm associated therewith or it ma come from a control system 16 that wants to validate or verify a hitch angle provided by a hitch angle sensor. Examples of vehicle control systems 16 that may request hitch angle information may be a trailer backup assist system, a trailer sway control system, a trailer brake control system, and a vehicle dynamic control system such as roll stability control or yaw stability control. These are only a few examples of systems 16 that may utilize hitch angle information as an input to a control algorithm.

An operation 104 is performed to monitor power returns of signals transmitted from the trailer to the vehicle. Path loss is proportional to the square of the distance between the transmitter and the receiver and power returns of signals transmitted may be used to estimate a distance between the transmitter and the receiver. The power returns are measured, at the receiver, at predetermined time intervals and stored in controller memory over a predetermined period of time. The power returns may be accessed by the controller for various operations and/or functions that use the values to estimate hitch angle.

An operation 106 is performed to estimate the distance, d, between the transmitter and the receiver. Estimating the distance, d, between the wireless transmitter and the wireless receiver 106 is accomplished by using the, measured power returns or measured path loss of the signal being transmitted. Path loss is proportional to the square of the distance between the transmitter and the receiver, and also to the square of the frequency of the transmitted signal. Signal propagation may be represented by Friis transmission formula:

$${P}_{r} ( d ) = \frac{{P}_{t} {G}_{t} {G}_{r} {λ}^{2}}{{( 4 π )}^{2} {d}^{2} L} \qquad ( 1 )$$

where Pₜ is the transmission power in Watts, Gₜ and Gᵣ are gains associated with the receiver and the transmitter respectively, λ is the wavelength, L are system losses, and d is the distance between the transmitter and the receiver. Transmission power decreases at a rate proportional to d². Therefore, knowing the path loss, PL, associated with the transmitted signal will provide an estimate of the distance, d, between the transmitter and the receiver. Path loss (PL) is represented by:

$$\begin{matrix}{PL}_{dB} = 10 log \frac{{P}_{t}}{{P}_{r}} = - 10 log ( \frac{{G}_{t} {G}_{r} {λ}^{2}}{4 {π}^{2} {d}^{2} L} ) & ( 2 ) \\ {PL}_{dB} = - 10 log ( \frac{{G}_{t} {G}_{r} {λ}^{2}}{{( 4 π )}^{2} L} ) + 10 log ( {d}^{2} ) & ( 3 ) \\ {PL}_{dB} = - 10 log ( \frac{{G}_{t} {G}_{r} {λ}^{2}}{{( 4 π )}^{2} L} ) + 20 log ( {d}^{2} ) & ( 4 )\end{matrix}$$

Pᵣ decreases at a rate that is proportional to d². The power of the signal received at the receiver may be represented as:

$${P}_{r} ( d ) = {P}_{r} ( {d}_{0} ) {( \frac{{d}_{0}}{d} )}^{2} for d > {d}_{0} > {d}_{f} \qquad ( 5 )$$

The distance, d, may be derived from this formula and represents the overall distance between the transmitter on the trailer and the receiver on the vehicle. The distance, d₀, is a known received power reference point and the distance, d_{f}, is a far-field distance.

The reference distance, dᵣ, is known. if the trailer length, l_{T} is known, then an operation 108, using the distance, d, the trailer length, l_{T}, the known reference distance, dᵣ, between the receiver and the trailer hitch, and the law of cosines, is performed to calculate the hitch angle. From the law of cosines:

A²=B²+C²+2BCcos(α) (6)

The hitch angle, α, is given by:

$$a = {cos}^{- 1} [ \frac{{A}^{2} - {B}^{2} - {C}^{2}}{- 2 BC} ] \qquad ( 7 )$$

An operation 110 is performed in which the vehicle system that is requesting the information receives the hitch angle estimation. The inventive subject matter provides an estimate of hitch angle even when a hitch angle sensor is unavailable. If a system relies on a hitch angle sensor, the inventive subject matter may provide verification, as a redundant sensor, that the hitch angle sensor is operating properly.

As discussed above, the trailer length, l_{T}, may be a known value stored in memory or it may be a value that is calculated according to the inventive subject matter. The trailer length may be calculated 112 by comparing distances, d, between the transmitter and the receiver that have been estimated and stored in memory over a period of time. A predetermined number of distance estimates may be stored in controller memory. A comparison of the stored distances may result in a largest distance may be identified. The largest distance estimate may be associated with a zero hitch angle. This identified largest distance, less the known reference distance, dᵣ will be representative of, and may be stored as, the trailer length, l_{T}.

As an alternative, the trailer length, l_{T}, may be estimated using a yaw rate provided by a yaw rate sensor on the vehicle to determine when the trailer is a zero hitch angle. A yaw rate sensor is typically available as part of the sensor systems 16 on the vehicle. A zero yaw rate is an indicator that a vehicle is travelling along a straight path, i.e., the vehicle is not turning. The fact that the yaw rate is zero alone is not adequate to identify a zero hitch angle because the vehicle may have just stopped turning even though a non-zero hitch angle exists. However, monitoring yaw rate over time will provide confirmation that the vehicle has driven straight forward for a sufficient predetermined period of time while maintaining a zero or near zero yaw rate. A zero yaw rate, sensed over time, provides an indication that the trailer has straightened out and it can be inferred that the hitch angle is zero at that point. Upon verification of zero hitch angle, the operation to calculate trailer length 112 is performed. The estimated distance between the transmitter and the receiver when the hitch angle is zero less the predetermined distance, dᵣ, defines the trailer length, l_{T}.

The predetermined period of time that the yaw rate should remain at zero before the assumption that the hitch angle is zero will be associated with an actual distance the vehicle trailer combination needs to travel to ensure that the hitch angle is zero. This may be determined through testing and stored in the controller memory.

The inventive subject matter is advantageous in that it provides an estimate of hitch angle whether or not a hitch angle sensor is present on a vehicle. The inventive subject matter is even advantageous for a vehicle that has a hitch angle sensor in that it provides a method for verifying, or validating, the accuracy of a hitch angle sensed by a hitch angle sensor. This is especially important for vehicle systems that rely critically on the value of the hitch angle being sensed, for example, trailer backup assist systems, trailer sway control systems and trailer brake control systems.

In the foregoing specification, the inventive subject matter has been described with reference to specific exemplary embodiments. Various modifications and changes may be made, however, without departing from the scope of the inventive subject matter as set forth in the claims. The specification and figures are illustrative, rather than restrictive, and modifications are intended to be included within the scope of the inventive subject matter. Accordingly, the scope of the invention should be determined by the claims and their legal equivalents rather than by merely the examples described.

For example, the steps recited in any method or process claims may be executed in any order and are not limited to the specific order presented in the claims. The equations may be implemented with a filter to minimize effects of signal noises. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the inventive subject matter, in addition to those not specifically recited, may be varied or otherwise particularly adapted to specific environments, manufacturing specifications, design parameters or other operating requirements without departing from the general principles of the same.

1. A system for estimating hitch angle between a trailer having a transmitter disposed thereon coupled to a vehicle having a trailer mount and a receiver disposed on the vehicle a first distance from the trailer mount, comprising:
a controller to calculate a second distance between the transmitter and the receiver as a function of path loss propagation and estimating a hitch angle using the first distance, the second distance and a trailer length.

2. The system as claimed in claim 1 wherein the trailer length is stored in controller memory.

3. The system as claimed in claim 1 further comprising a hitch angle sensor for sensing a hitch angle and wherein the controller compares the estimated hitch angle with the sensed hitch angle to verify an accuracy of the sensed hitch angle.

4. A method executed by a controller on a vehicle for calculating an angle between a vehicle and a trailer coupled thereto, comprising:
monitoring power returns of a signal transmitted from a transmitter at one end of the trailer to a receiver on the vehicle located a first distance from a trailer mount;
estimating a second distance between the transmitter and the receiver, the second distance being a function of a path loss propagation of the transmitted signal;
calculating an angle between the vehicle and the trailer using the second distance, the first distance and a trailer length; and
outputting the calculated angle to a vehicle system.

5. The method as claimed in claim 4 wherein the trailer length is stored in controller memory.

6. The method as claimed in claim 4 wherein the trailer length is calculated and the method further comprises the steps of:
estimating, over time, the distance between the transmitter and the receiver at predetermined time intervals;
storing a predetermined number of second distances;
identifying which of the stored distances is largest; and
deducting the first distance from the largest stored distance to define the trailer length.

7. The method as claimed in claim 4 wherein the trailer length is calculated and the method further comprises the steps of:
monitoring, over time, an output signal of a yaw rate sensor;
defining a zero hitch angle when the yaw rate sensor output is zero for a predetermined amount of time:
for a signal transmitted from the transmitter to the receiver during the defined zero hitch angle, estimating a zero-hitch-angle-distance between the transmitter and the receiver that is a function of path loss propagation of the transmitted signal; and
deducting the first distance from the zero-hitch-angle distance to define the trailer length.

8. The method as claimed in claim 4 wherein the vehicle further comprises a hitch angle sensor and the method further comprises the steps of:
receiving a hitch angle sensed by the hitch angle sensor; and
comparing the calculated angle with the sensed hitch angle to verify an accuracy of the sensed hitch angle.

9. A hitch angle estimation system for a vehicle having a trailer mount and a receiver disposed thereon a first distance from the trailer mount, the vehicle being coupled to a trailer having a transmitter, comprising:
a controller that monitors power returns of a signal transmitted between the transmitter and the receiver as a function of path loss propagation of the transmitted signal and estimates a distance between the transmitter and the receiver, the controller calculates a hitch angle using the first distance, the estimated distance and a trailer length.

10. The system as claimed in claim 9 wherein the trailer length is stored in controller memory.

11. The system as claimed in claim 9 wherein the trailer length is calculated by the controller, the controller stores a predetermined number of estimated distances, the controller identifies a largest of the stored distances, and the controller defines the trailer length by deducting the first distance from the largest distance.

12. The system as claimed in claim 9 wherein the trailer length is calculated by the controller, the controller monitors, over time, signal information from a yaw rate sensor or the vehicle that is representative of a vehicle yaw rate, the controller defines a zero hitch angle when the sensed yaw rate is zero fir a predetermined amount of time, the controller estimates a zero-hitch-angle-distance between the transmitter and the receiver for the defined zero hitch angle, the zero-hitch-angle-distance being a function of a path loss propagation of the transmitted signal, and the controller sets the trailer length equal to the zero-hitch angle distance less the first distance.

13. The system as claimed in claim 9 further comprising a hitch angle sensor for providing a sensed hitch angle to a vehicle system and wherein the controller compares the estimated angle with the sensed hitch angle to verify an accuracy of the sensed hitch angle.
